(19) United States
(12) Patent Application Publication
(10) Pub. No.: US 2026/0219775 A1
(43) Pub. Date: Jul. 30, 2026

(54) GRAPHICAL ELEMENT MODIFICATION

(71) Applicant: Lenovo Global Technology (United States) Inc., Morrisville, NC (US)

(72) Inventors: Diana Gerli, Raleigh, NC (US); Mark Delaney, Raleigh, NC (US); John C. Mese, Cary, NC (US); Nathan Peterson, Oxford, NC (US)

(21) Appl. No.: 19/041,792

(22) Filed: Jan. 30, 2025

(51) Int. Cl. G06F 3/04845; G06F 3/04817

(52) U.S. Cl. CPC G06F 3/04845; G06F 3/04817

(57) ABSTRACT

One embodiment provides a method, the method including: identifying, using a graphical element modification system, a graphical element displaying state change information that is to be presented as an overlay on a display device; identifying, using the graphical element modification system, a feature of content displayed on the display device, wherein the feature affects a visibility of the graphical element; adjusting, using the graphical element modification system, a characteristic of the graphical element in view of the feature; and transmitting, using the graphical element modification system, instructions to display the graphical element having the adjusted characteristic. Other aspects are claimed and described.

### BACKGROUND

Many users utilize multiple displays when working with an information handling device (e.g., laptop, tablet, smart phone, personal computer, etc.). The users may utilize a display that is integral to the device, may utilize external displays, and/or a combination thereof. Generally, the device can be used to control different functions of the device, display, or other component (e.g., speaker, media ports, image capture device, audio output device, audio input device, etc.). The device may have a button or other input element to which a user can provide input that controls a function. For example, an input element may control the brightness of a display, may control a volume of a speaker, may disable ports on a device, may turn on/off a power saving mode of a device, may turn on/off airplane mode of a device, and/or the like. These input elements allow a user to quickly control the desired function. In order to inform the user that an input has been detected at one of these input elements, the device may generate an on-screen display icon that displays the state change information. These on-screen display icons are presented as an overlay on one of the displays of the device or that is connected to the device.

### BRIEF SUMMARY

In summary, one aspect provides a method, the method including: identifying, using a graphical element modification system, a graphical element displaying state change information that is to be presented as an overlay on a display device; identifying, using the graphical element modification system, a feature of content displayed on the display device, wherein the feature affects a visibility of the graphical element; adjusting, using the graphical element modification system, a characteristic of the graphical element in view of the feature; and transmitting, using the graphical element modification system, instructions to display the graphical element having the adjusted characteristic.

Another aspect provides a system, the system including: a processor; a memory device that stores instructions that, when executed by the processor, causes the system to: identify, using a graphical element modification system, a graphical element displaying state change information that is to be presented as an overlay on a display device; identify, using the graphical element modification system, a feature of content displayed on the display device, wherein the feature affects a visibility of the graphical element; adjust, using the graphical element modification system, a characteristic of the graphical element in view of the feature; and transmit, using the graphical element modification system, instructions to display the graphical element having the adjusted characteristic.

A further aspect provides a product, the product including: a computer-readable storage device that stores executable code that, when executed by a processor, causes the product to: identify, using a graphical element modification system, a graphical element displaying state change information that is to be presented as an overlay on a display device; identify, using the graphical element modification system, a feature of content displayed on the display device, wherein the feature affects a visibility of the graphical element; adjust, using the graphical element modification system, a characteristic of the graphical element in view of the feature; and transmit, using the graphical element modification system, instructions to display the graphical element having the adjusted characteristic.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

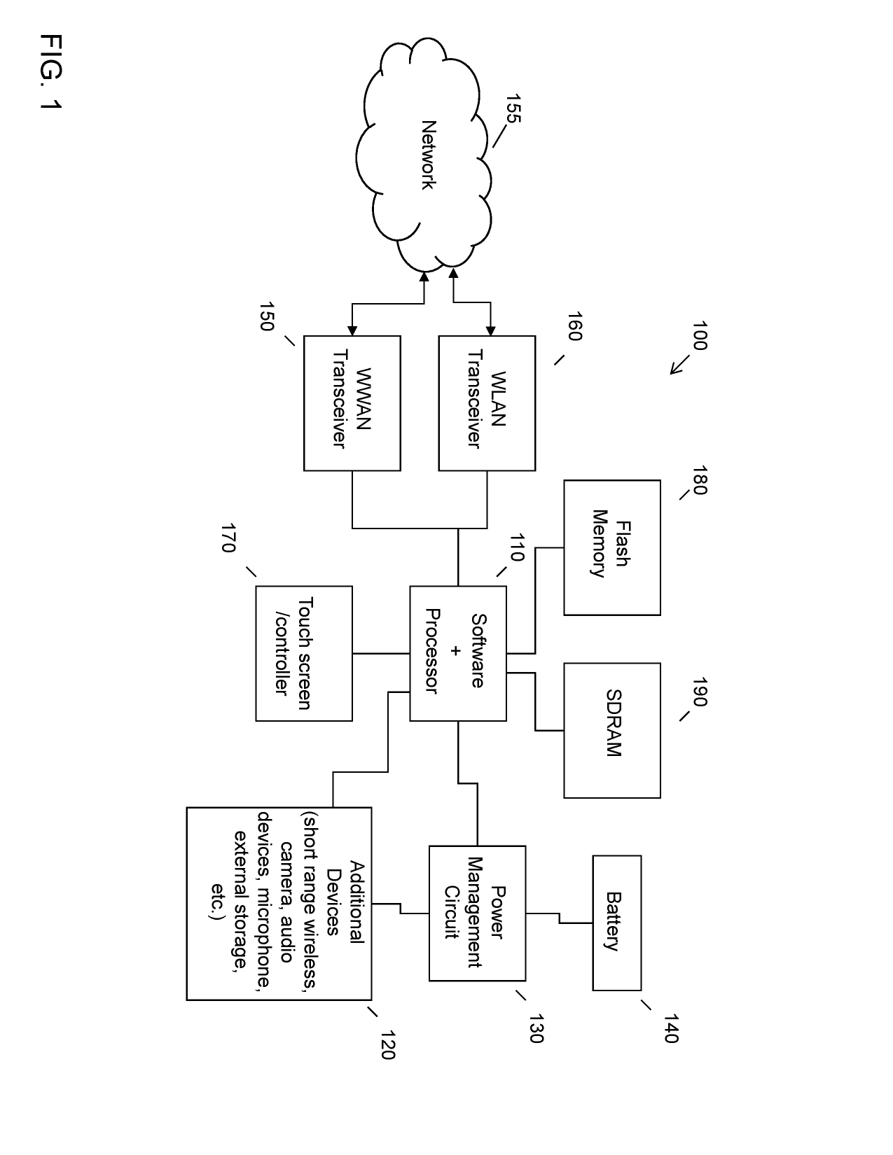

FIG. 1 illustrates an example of information handling device circuitry.

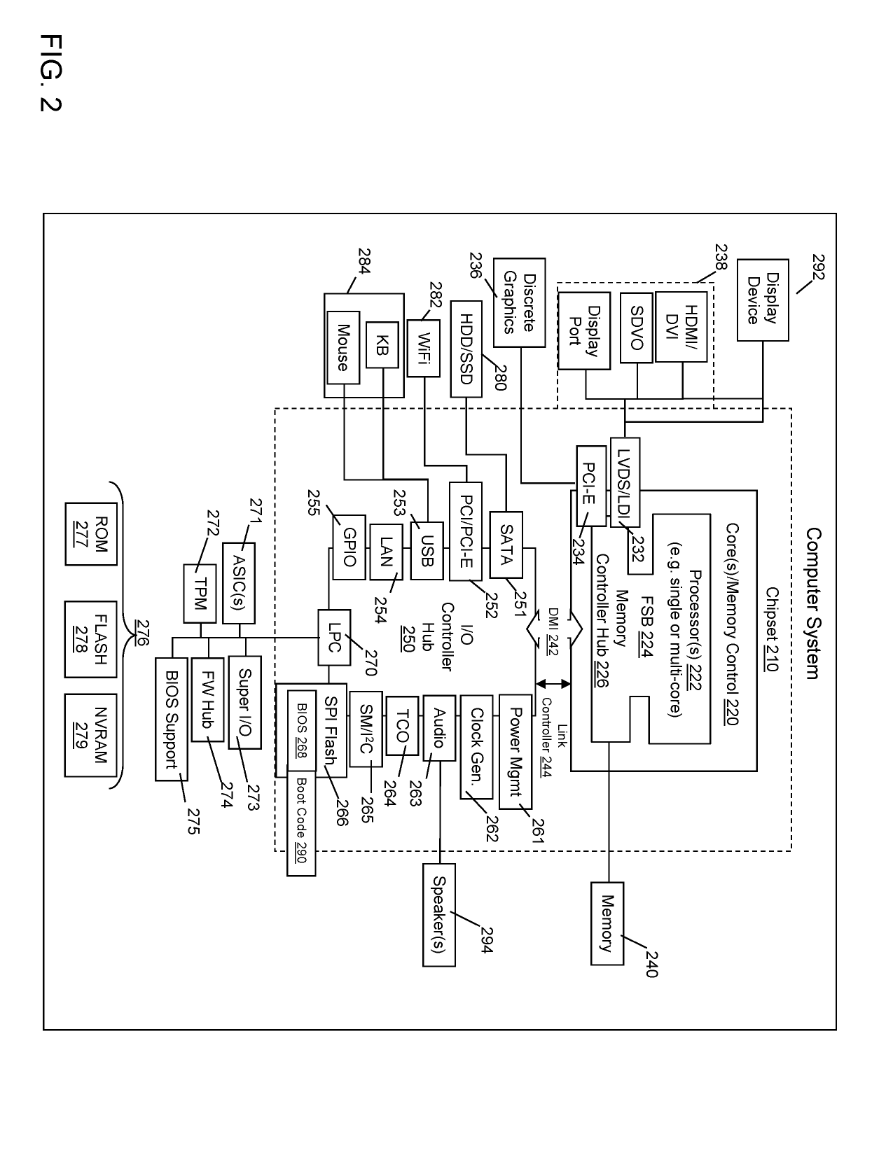

FIG. 2 illustrates another example of information handling device circuitry.

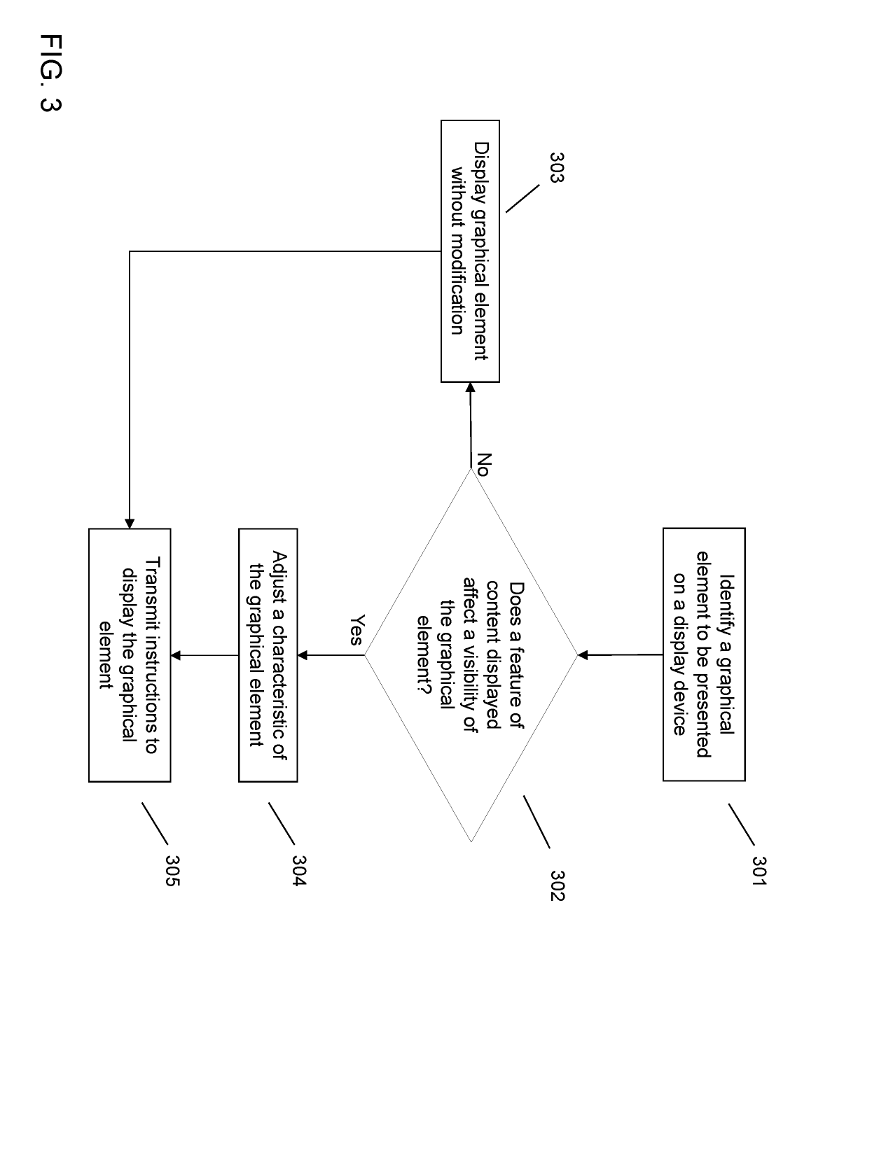

FIG. 3 illustrates an example method for adjusting a characteristic of a graphical element based upon identifying a feature of content displayed on a display device and identifying the feature affects a visibility of the graphical element.

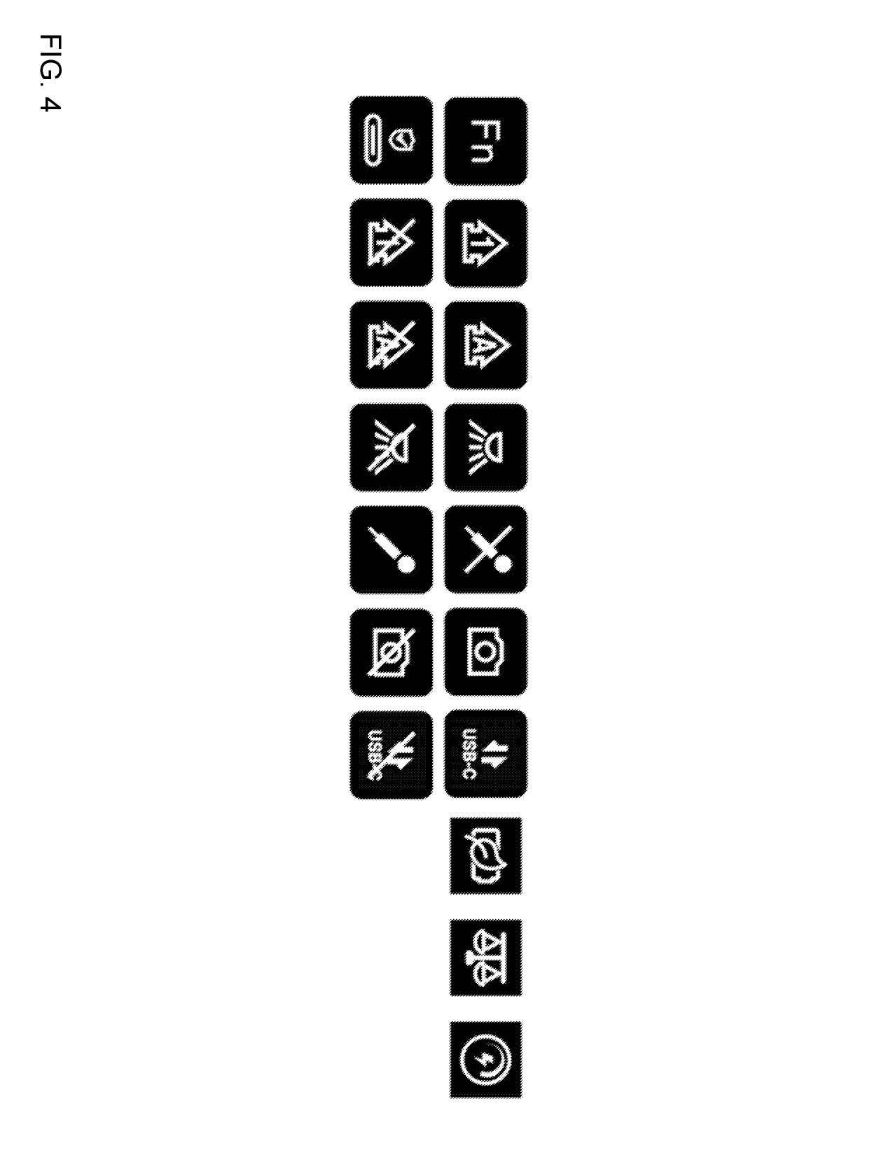

FIG. 4 illustrates some example on-screen display graphical elements.

### DETAILED DESCRIPTION

On-screen display icons or graphical elements are graphical overlays that provide information or controls. On-screen display icons are commonly used to display state change information for the information or controls. While on-screen display elements are displayed upon a display device, these icons are not only for displaying state change information of display devices. In other words, on-screen display icons or graphical elements may correspond to state changes of components other than display devices. Some example on-screen display graphical elements include, but are not limited to, display brightness adjustments, media port disable/enable, power save mode enable/disable, airplane mode disable/enable, and/or the like. Additionally, some components have their own input elements that result in the provision of on-screen display icons or graphical elements. For example, a display device may have buttons located on the display device that, when pressed, result in the provision of an on-screen display graphical element.

When a user provides input to an input element (e.g., button, soft control, sequential button press, combined button press, key, etc.) that results in the display of an on-screen display graphical element, the graphical element is usually provided at the same location on a display device. Additionally, the location of the on-screen display graphical elements does not vary even when multiple display devices are connected to the information handling device. Multiple display devices are useful for displaying multiple pieces of information at the same time because they provide additional space for the display of information. However, when a user provides an input to an input element that results in the display of an on-screen display icon, having multiple display devices can complicate the display of the on-screen display icons. The provision of the on-screen display graphical element allows the user to quickly discern that the input provided at the input element was detected and also identify the current state of the component or function corresponding to the input element. Generally, these graphical elements are only displayed for a short duration. With multiple display devices, the user may be unable to quickly locate the graphical element because the user may not know which display device the graphical element will be displayed upon. Additionally, depending on the content on the display device, on-screen display graphical elements may be difficult to see.

Accordingly, the described system and method provides a technique for adjusting a characteristic of a graphical element based upon identifying a feature of content displayed on a display device and identifying the feature affects a visibility of the graphical element. The graphical element modification system identifies a graphical element that is to be presented as an overlay on a display device. The graphical elements are on-screen display graphical elements that are displayed as overlays on a display device, which means that the graphical element will be located at the forefront of the content on the display device regardless of what content is currently displayed on the display device. Such on-screen display graphical elements display state change information for a device, component, or system. The on-screen display graphical element may be identified from receipt of input at an input element that results in a state change of a characteristic of the device, component, or system.

Before displaying the on-screen display graphical element, the graphical element modification system identifies a feature of content that is currently displayed on the display device. The feature of the content affects the visibility of the on-screen display graphical element. One feature may be a color scheme of the content. Another feature may be a location of content on the display device, particularly if the content is focus content, or content or a graphical object within the content that is being focused on by a user (e.g., content receiving attention from a user and/or intended to receive attention from a user). Another feature may be a focus location of a user, where the focus location is one of multiple display devices that are connected to a device or a portion of one or more display devices that are connected to a device. A final, non-limiting feature, may be a feature that indicates a reduced visibility of content to a user who is viewing the content.

In view of the identified feature, the graphical element modification system adjusts a characteristic of the on-screen display graphical element. In other words, the system determines there is a feature of the content that indicates that a traditional placement and appearance of the on-screen display graphical element will affect the visibility of the graphical element. For example, if the color scheme of the content is similar to the color scheme of the graphical element, it may be difficult to see the graphical element. Thus, the system may adjust the color or appearance of the graphical element to make it more visible. As another example, if the traditional location of the graphical element will result in the obscurement of focus content or a focus graphical object, the user may be unable to focus on the graphical element and the visibility of the focus graphical object is also decreased. Thus, the system may adjust a location of the graphical element to make it more visible and less distracting. As another example, if the focus location from multiple displays is different than the traditional placement location on the primary display device, the system may move the graphical element to the display device the user is utilizing or focused upon to make it more visible. As a final non-limiting example, if the user has reduced visibility, the system may provide additional output in addition to displaying the graphical element so that the user can be informed of the provision of the graphical element. Once the adjustment has been made to the characteristic, the graphical element modification system transmits instructions to display the graphical element having the adjusted characteristic.

Therefore, a system provides a technical improvement over traditional methods for displaying graphical elements that display state change information. The described system and method provide on-screen display graphical elements that are located on a display device that the user is focused upon, instead of on a default display device which is generally the primary display device as found in conventional techniques. Additionally, the system identifies a color scheme of the content that is displayed upon the display device where the on-screen display graphical element is to be displayed and ensures that the color and/or appearance of the on-screen display graphical element is different than or contrasted with the content color scheme so as to make the on-screen display graphical element noticeable and obvious to a user who is viewing the display device.

Additionally, if certain content that the user is focusing upon is located where the on-screen display graphical element is to be displayed, the system will move the on-screen display graphical element to prevent the graphical element from covering the focus content. Finally, the system is able to provide output using modalities in addition to the visual display of the on-screen display graphical element so that users who may have difficulty visualizing information can also be provided with another output that identifies that the state change has been made. Accordingly, the described system and method provides techniques that result in a displaying of on-screen display graphical elements that increase user awareness, that provide for increased user accessibility, and that incorporate situational adjustments as compared to traditional techniques for displaying on-screen display graphical elements.

The illustrated example embodiments will be best understood by reference to the figures. The following description is intended only by way of example, and simply illustrates certain example embodiments.

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be devices that are used to by users with display devices, that house or provide access to the graphical element modification system, and/or the like. For example, the circuitry outlined in FIG. 1 may be implemented in a tablet or smart phone embodiment, whereas the circuitry outlined in FIG. 2 may be implemented in a personal computer embodiment.

FIG. 3 illustrates an example method for adjusting a characteristic of a graphical element based upon identifying a feature of content displayed on a display device and identifying the feature affects a visibility of the graphical element. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to adjust a characteristic of a graphical element based upon a feature of content displayed on a display device. Additionally, the graphical element modification system includes modules and features that are unique to the described system.

The graphical element modification system may be activated in order to adjust a characteristic of an on-screen display graphical element, also referred to as a graphical element for ease of readability, based upon identifying that a feature of content displayed on a display device affects a visibility of the graphical element. Thus, the graphical element modification system may be activated upon detection of an input at an input element that controls a state change of a function of a system, component, or device. The system can identify if the traditional presentation of the graphical element, including a traditional appearance and location of the graphical element, needs to be adjusted in order to increase the visibility of the graphical element. Upon making an adjustment to the characteristic of the graphical element, the system can transmit instructions to display the graphical element having the adjusted characteristic.

Activation of the graphical element modification system may be a manual activation of the graphical element modification system and/or an automatic activation of the graphical element modification system. Manual activation of the system may include a user opening an application associated with the graphical element modification system, the user accessing the computing system associated with the graphical element modification system, and/or the user otherwise providing input to the graphical element modification system. The automatic activation of the graphical element modification system may be based upon the detection of a trigger event indicating that the system should be activated. Example trigger events include the user providing input to an input element that results in the presentation of an on-screen display graphical element, a user accessing an application that interfaces with the graphical element modification system, activation of software or an application utilizing the graphical element modification system, and/or the like.

The graphical element modification system may be made of multiple systems or modules that communicate together to make up the graphical element modification system or may be a single system. The graphical element modification system may be a standalone system, may be accessible through other computing devices, and/or a combination thereof. For example, the graphical element modification system may be a standalone system that can be accessed by a user and/or may be or provide an application that is accessible by a user on another computing device. The graphical element modification system may be accessible using any type of computing device, for example, personal computer, laptop computer, smartphone, tablet, smartwatch, head-mounted display, smart television or other smart appliance, augmented reality device, virtual reality device, and/or the like.

Thus, the graphical element modification system may be accessible locally using a computing device where the graphical element modification system is installed and/or may be accessible remotely through another computing device. For example, the graphical element modification system may be accessed by a user using a device that communicates with the graphical element modification system to identify an on-screen display graphical element is to be displayed on a display device, identify a feature of content that affects a visibility of the graphical element, adjust a characteristic of the graphical element, transmit instructions to display the graphical element, and/or the like. However, the graphical element modification system may be located and operate on a different information handling device to perform the described steps.

The graphical element modification system may have an associated graphical user interface. The graphical user interface may be provided on a display or monitor, which may or may not be associated with the graphical element modification system. In other words, the graphical element modification system may have a dedicated display or monitor or may be accessible using any display or monitor. In either case, the graphical element modification system may provide instructions to generate and display the graphical user interface on the display device being used to access the graphical element modification system. The graphical user interface may also be updated and managed based upon instructions provided by the graphical element modification system. In other words, the graphical element modification system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the graphical element modification system. For example, the graphical element modification system may utilize a user profile, historical information, and/or the like, to identify a feature of content affects a visibility of the graphical element, determine that a characteristic of an on-screen display graphical element is to be adjusted, transmit instructions to display the graphical element, and/or the like. The graphical user interface may allow for creation of or access to these profiles, historical information, and/or the like, by allowing a user to input information regarding user preferences, accessibility information, and/or the like. As will be discussed in more detail, the use of user provided information is not the only way that the profile and/or historical information can be created. The graphical element modification system can then utilize these inputs, whether provided directly by the user or identified using a different technique, to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, and/or the like. It should be noted that the information to be used by the graphical element modification system and information provided by the graphical element modification system can be different for different applications, different computing systems, different users, and/or the like. Thus, the information corresponding to input or output of the graphical element modification system are not always the same. However, the graphical element modification system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The graphical element modification system may utilize one or more artificial intelligence models in identifying a feature of content displayed on a display device that affects a visibility of the graphical element and determining how to adjust a characteristic of the graphical element in view of the feature. Artificial intelligence models could be designed to identify a feature of content and determine if it affects the visibility of a graphical element, to adjust a characteristic of the graphical element in view of a feature, or any other steps within the described system. Artificial intelligence models may also be used for steps within a step. For example, a model could be utilized to detect a focus of a user to determine that the feature of the content affects a visibility of the graphical element, identify the feature to determine how the feature affects a visibility of the graphical element to determine how the graphical element should be adjusted, generate instructions to transmit to display the graphical element, and/or the like.

For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model (e.g., a general model, such as a general classification model) that is fine-tuned for the graphical element modification system, or the artificial intelligence model may be a model that is created and trained from scratch. Since the graphical element modification system is used in conjunction with identifying features of content and adjusting characteristics of an on-screen display graphical element, some models that may be utilized by the system are image analysis models, text analysis models, audio analysis models, analysis models, similarity identification models, language models, large language models, entity identification models, input analysis models, filtering models, classification models, and/or the like. The model may be trained using one or more training datasets.

Additionally, as the model is deployed, it may receive feedback to become more accurate over time. Alternatively, or additionally, the model may utilize inputs provided to the model to learn continually, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

The feedback or inputs could be stored within a data store and utilized at a later time to train or retrain the model. For example, a user could use the feedback to update a training dataset to train or retrain the model. The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

As previously mentioned, an ensemble of models or multiple models may also be utilized. Some example models that may be utilized are variational autoencoders, generative adversarial networks, recurrent neural networks, convolutional neural networks, deep neural networks, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The graphical element modification system may include different components for carrying out different functions of the system, including different steps to be performed. These components may be hardware components or software components. Some hardware devices or components that may be utilized by the graphical element modification system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the graphical element modification system. For example, the graphical element modification system may include speakers, displays or monitors, haptic output devices, audio output devices, and/or the like. Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the graphical element modification system, and/or the like.

One software component may include a data storage location or data repository that stores information related to accessibility options, user profiles, and/or the like. The data storage location or data repository may also store information related to on-screen display graphical elements. Information may be stored in the data storage location using any data storage technique. Additionally, the system can access the information stored within the data storage location using any type of querying technique, filtering technique, and/or the like. The information contained within the data storage location may also be organized, for example, grouped by on-screen graphical element type, grouped by user, grouped by input elements, and/or the like.

Another software component includes a user profile that stores information related to a user and user preferences. The graphical element modification system may utilize information contained within a user profile to identify that a feature of content affects a visibility of the graphical element and/or determine how to adjust a characteristic of a graphical element in view of an identified feature. Thus, the user profile may include information related to viewability of content and graphical elements, settings for external components (e.g., primary components, most used components, preferences for components, etc.), and/or the like. This information may be identified by the user through manual input, or may be identified by the graphical element modification system as the user utilizes the system and modifications are made to graphical elements. Thus, the graphical element modification system can monitor inputs provided by a user at both a device and also at external components. Once the user has provided inputs (e.g., manual input, audible input, gesture input, etc.) to modify characteristics of graphical elements, the graphical element modification system can store this information or settings within the user profile.

The provided inputs may also be inputs that are inferred from other inputs. In other words, the graphical element modification system may determine from user movements, facial expressions, gestures, audible input, and/or other inputs, that the user needs a characteristic of a graphical element adjusted. For example, a user may provide input to an input element that results in the display of an on-screen display graphical element, but may provide inputs that indicate the user has not seen the on-screen display graphical element (e.g., providing input the input element multiple times, appearing confused or frustrated that the graphical element has not been noticed, looking for the graphical element on the display device, etc.). The system could then infer from such inputs that a characteristic of the graphical element needs to be adjusted because the graphical element is not visible to the user. The system can also infer that a feature of content being displayed is affecting a visibility of the graphical element. Thus, the graphical element modification system may monitor a user for inputs other than those inputs provided directly to the input element.

In inferring or correlating characteristic adjustments or settings, identifying a feature of content is affecting a visibility of a graphical element, and/or the like, the system may utilize one or more techniques that allows for the inference or identification of information including, but not limited to, rules engines, artificial intelligence models, correlation techniques, and/or the like. These techniques may take the identified information as input, analyze that input based upon the technique programming, and provide an output related to the desired information. This information may then be placed within the user profile for later access.

The user profile may also contain other information, for example, information related to preferences of the user. For example, the user profile may include information related to when the graphical element modification system should identify a feature is affecting a visibility of a graphical element, determining whether a characteristic of a graphical element should be adjusted, and/or the like. Any of the mentioned profiles, or other profiles, may include additional information that may be useful for the graphical element modification system and may be entered by a user, may be default values, may be learned by the system over time, and/or the like. Thus, profiles can be populated with information manually by a user, entities or companies, and/or the like, or can be populated over time as the system learns more about the user, models, entities or companies, and/or the like. For example, a user may manually provide input to a user profile and the system can learn preferences about the user over time and populate the user profile with this learned information.

Learned information may be information learned based upon direct inputs, for example, a user may be presented with a pop-up window in response to a trigger and provide input to the pop-up window. This input can be then populated into the user profile. Learned information may also be information learned based upon indirect inputs, for example, a user may provide inputs (e.g., audible inputs, visual inputs, gesture inputs, etc.) that indicate that the user would like to display an on-screen display graphical element, learn how a graphical element should be adjusted to increase the visibility of the graphical element, learn what features of content affect the visibility of the graphical element, and/or the like. The system can then aggregate this information to learn preferences of the user. Similarly, the system can learn information for other profiles. With respect to the described graphical element modification system, the learned information may include historical information, determinations of when features affect the visibility of a graphical element, determinations of when characteristics of graphical elements should be adjusted, and/or the like.

At 301, the graphical element modification system, identifies a graphical element displaying state change information that is to be presented as an overlay on a display device. The graphical element is an on-screen display graphical element, which will be referred to as a graphical element for ease of readability. An on-screen display graphical element or icon, is a graphical element that is overlaid on a display device at the forefront of the content currently being displayed on the display device. In other words, an on-screen display graphical element is one that will always be displayed at the forefront of the content, regardless of the content that is currently being displayed on the display device. Additionally, an on-screen display graphical element illustrates a state change for a function of a component, system, or device. Thus, the on-screen display graphical element is displayed to illustrate that a state change has been made to a function for a component, system, or device. Example on-screen display graphical elements are illustrated in FIG. 4. State changes may include, but are not limited to, an enabling or disabling of a component (e.g., media devices, ports of a device, etc.), an increase or decrease in a function (e.g., brightness adjustment, volume adjustment, etc.), an activation or deactivation of a mode (e.g., power saving mode, airplane mode, energy efficiency mode, etc.), and/or the like.

The on-screen display graphical element, while displayed on a display device, does not necessarily display state change information for only the display device. Rather, the on-screen display graphical element can correspond to state change information for any component, system, or device that is in communication with the display device, whether that is direct communication or indirect communication. For example, a speaker that is connected to a device that is connected to an external display can be affected by a state change, where the graphical element corresponding to the state change will be displayed on the external display, even though the speaker is not directly connected to the external monitor but rather connected through the device which is connected to both the speaker and the external display.

To identify that a graphical element is to be presented on a display device, the graphical element modification system may identify that an input has been received at an input element. An input element may be any type of element that input can be provided to or through, for example, a button, key, voice capture device, gesture capture device, image capture device, mouse, touch screen, soft key, electromyography device, and/or the like. The input element may be associated with the graphical element. In other words, the input element may be an input element that results in a state change that corresponds to the state change identified by the graphical element. The input element may be an input element that is dedicated to a function whose state can be changed. For example, the input element may be an input element that is dedicated to the function of airplane mode. Thus, providing input to the input element will result in a state change to airplane mode, either enabling or disable airplane mode depending on the current state of the airplane mode function. The input element may also be an element that is not dedicated to the function whose state can be changed.

Accordingly, the input at the input element may include input provided at multiple input elements, either sequentially or in combination. For example, the input may be provided at an input element with a modifier input (e.g., modifier key, modifier button, modifier gesture, modifier audible output, etc.). Thus, the detected input can be any input that is necessary to effectuate the state change, regardless of whether that is input at a single input element, input at multiple input elements, sequential input at multiple input elements, sequential input at a single input element, and/or the like. However, for ease of readability, the description will discuss input provided at an input element. However, this is not intended to limit the input to a single input element.

At 302, the graphical element modification system may identify if a feature of content being displayed on a display device will affect a visibility of the graphical element if it were to be displayed in the traditional manner. In other words, the graphical element modification system identifies a feature of content that is currently displayed on the display device, where the feature affects a visibility of the graphical element. Identifying a feature of content that affects a visibility of the graphical element may include identifying content that is currently being displayed on the display device that would result in the graphical element being difficult for the user to see or causing a reduction in the visibility of the graphical element. Identifying a feature of content may include identifying a feature of the content that can be utilized to infer that graphical element will be difficult for the user to see, even if the content itself is not obscuring or resulting in the graphical element being difficult to see or causing the reduction in the visibility of the graphical element. Identifying a feature of content may include identifying content that would be obscured by the graphical element, thereby reducing the visibility of the graphical element since the user is trying to focus on the content. Identifying a feature of content may include identifying a location of focus of the user and identifying the graphical element would be located at a location that is different than the focus location, thereby reducing the visibility of the graphical element.

In identifying a feature of content displayed on the display device, the graphical element modification system may determine that the feature affects the visibility of the graphical element. Thus, in addition to identifying the feature of content, the system may also determine whether the feature affects the visibility of the graphical element. If the feature does not affect the visibility of the graphical element, then the system may not identify it as a feature. In other words, features or characteristics of the content that do not affect a visibility of the graphical element may be ignored or no further analysis may be conducted with respect to such features or characteristics. To determine if the feature affects the visibility of the graphical element, the system may perform different analyses, which may be dependent upon the feature being analyzed, to determine an effect, if any, on the visibility of the graphical element.

Some analyses that may be performed include providing input to analysis system which may be a rules engine, artificial intelligence model, similarity analysis system, comparison system, and/or the like. The analysis system may then analyze the input per the programming of the analysis system. The analysis system may then provide an output that identifies whether a visibility of the graphical element is affected by the feature. It should be noted that multiple analysis systems could be utilized sequentially, in parallel, in combination, and/or the like. Thus, the feature may be analyzed using one or more analysis systems.

It should be noted that the degree of the effect of the feature may vary. In other words, the graphical element modification system does not have to determine that the feature will reduce the visibility of the graphical element completely. Rather, the system may determine that the feature will reduce the visibility of the graphical element by a particular percentage or more, as compared to a threshold visibility value, that the visibility is affected at all, and/or the like. How much the visibility of the graphical element has to be affected may vary based upon user, may be identified within the user profile, may be learned by the system over time, may vary based upon the function corresponding to the graphical element, may vary based upon content that is being displayed on the display device, and/or the like.

Some example features of content that may affect the visibility of the graphical element will be described herein. However, it should be noted that other features of content may affect the visibility of the graphical element and those features can be utilized to make a determination regarding whether a characteristic of the graphical element should be adjusted. The features of content refer to characteristics of the content that is being displayed on a display device and may include a color scheme of the content, an appearance of the content, a location of content, a focus graphical object within the content on which the user is focusing, a display device that is being actively used/viewed by the user, a size of content, whether additional outputs related to the displayed content are being provided (e.g., audio outputs, video outputs, gesture outputs, haptic outputs, etc.), a movement or animation of content, and/or the like. Thus, the features of the content can be any characteristics of the content.

Additionally, the system may analyze features of content that is the active content, features of all content that is visible, features of content in a particular location on a display device, features of the content within a particular application, features of content that may be affected by a state change, and/or the like. The content that is analyzed may be based upon different factors including, but not limited to, where the user is looking, information identified within a user profile, information learned by the system over time, active applications, the type of applications that are active, the components in communication with a device or system, the components, devices, or systems affected by the state change of the input element, and/or the like. The system could utilize information contained within a user profile to determine what content to analyze, may utilize artificial intelligence models to learn what content to analyze, utilize a rules engine to learn what content to analyze, may have default programming with respect to what content to analyze, and/or the like. Thus, the analysis of whether the feature affects the visibility may be contained to only the content that was identified for the analysis.

One example feature that may be analyzed to identify if the feature may affect the visibility of the graphical element includes a color scheme of the content. Accordingly, the graphical element modification system may identify the color scheme of the content. The color scheme of the content refers to not only the colors utilized within the content displayed on the display device, but also the color design (e.g., background colors vs. foreground colors, an amount of one color vs. an amount of other colors, a shading of colors, a pattern of colors with respect to other colors, a color palette, a color family, etc.). The system may identify the color scheme of the content that was identified as being selected for analysis. The graphical element modification system may compare the color scheme of the content to a default or previously set color scheme of the graphical element. In other words, the graphical element modification system may compare the color scheme of the content to a color scheme of the graphical element if no adjustments or modifications are made to the graphical element.

Another, similar, example feature that may be analyzed to identify if the feature may affect the visibility of the graphical element includes an appearance of the content. Accordingly, the graphical element modification system may identify the appearance of the content. The appearance of the content includes a design of the content, lines of the content, a font size of the content, a font style of the content, a size of graphical objects of the content, and/or the like. Thus, the appearance of the content includes a look and feel of the content. The system may identify the appearance of the content that was identified as being selected for analysis. The graphical element modification system may compare the appearance of the content to a default or previously set appearance of the graphical element. In other words, the graphical element modification system may compare the appearance of the content to an appearance of the graphical element if no adjustments or modifications are made to the graphical element.

To determine that the visibility of the graphical element will be affected, the system may compare the color scheme or appearance (e.g., shape, design, lines, font type, animation type, etc.) of the graphical element to the color scheme or appearance of the content being displayed on the display device where the graphical element is to be displayed. The system can compute a similarity score between the graphical element color scheme and/or appearance and the content color scheme and/or appearance. A similarity score that indicates a high level of similarity, a level of similarity above a predetermined threshold, a level of similarity that is less than completely dissimilar, and/or the like, may result in the system determining that the visibility of the graphical element will be affected. The similarity score can also be used to determine a degree of effect to the visibility of the graphical element.

Another example feature that may be analyzed to identify if the feature may affect the visibility of the graphical element includes a graphical object of focus within the content. A graphical object of focus within the content may be a graphical object that a user is viewing. A graphical object of focus may be identified even if the user is not actively viewing the graphical object at the time the analysis is performed. Rather, a graphical object of focus may be a graphical object that the user is frequently viewing, currently viewing, viewing at a predetermined frequency, viewing a certain percentage of time, and/or the like. Additionally, a graphical object of focus may be a particular type of active application or graphical object, regardless of whether the user is actively viewing the graphical object. The types of application or graphical objects that may be considered graphical objects of focus may be identified by a user within the user profile, may be selected or manually identified by the user, may be learned by the system over time, and/or the like. As an example, a video conferencing application that is actively transmitting video either from the user or to the user may be considered a graphical object of focus, even if the user is not actively looking at the application.

A graphical object of focus is a graphical object within the content that the user does not want to be obscured. Thus, a graphical object of focus may be a graphical object that is at least partially at the forefront of the content being displayed on the display device. Accordingly, since the user trying to view the graphical object of focus, placement of the graphical element on or over the graphical object of focus would obscure the graphical object of focus. Additionally, since the user is viewing the graphical object of focus, at least sometimes, the visibility of the graphical element would be affected because the user would not be focused on the graphical element and what it illustrates, but would instead be attempting to look past the graphical element. In other words, while the graphical element would not necessarily be obscured or difficult to view, the behavior of the user with respect to a placement of the graphical element will cause the visibility of the graphical element to be affected. Accordingly, the graphical object of focus can affect the visibility of the graphical element.

Another example feature that may be analyzed to identify if the feature may affect the visibility of the graphical element includes a number of display devices that are in communication with the device. Specifically, the graphical element modification system may identify that there is more than one display device that is integral to or otherwise connected to or in communication with the device. When more than one display device is available for the display of content, one of the display devices is generally considered the primary display device. Traditionally on-screen display graphical elements are displayed on the primary display device. For devices that have an integral display device and that are also connected to one or more external display devices, the primary display device is usually the integral display device.

However, frequently users do not utilize the integral display device at all, or the integral display device is not the display device that is being used as the primary display device by the user. The user can provide input to the device to reassign a display device as a primary display device, but there may be multiple reasons that the user does not perform these additional steps. Additionally, even if the user does perform these additional steps, the assigned primary display device may not always be used as the primary display device by the user and the user is not going to continually change the assignment as different display devices are used as the primary display device.

Thus, the graphical element modification system may identify which display device is being used as the primary display device of the user regardless of assignment. Similarly, the graphical element modification system may identify which of the display devices is being viewed by the user when the graphical element is to be displayed on a display device. Accordingly, the feature that may be identified is the focus location of the user, and, specifically, which of the displays of multiple displays is the current display being viewed by the user. If the graphical element were to be displayed on a different display as compared to the focus location of the user, the user may not see the graphical element because the user is not looking at a location or display device where the graphical element would be displayed. Thus, if the system determines a discrepancy between the display device where the graphical element is to be displayed and the focus location of the user, the system may determine that a visibility of the graphical element will be affected.

Determining a focus location of the user may include using gaze tracking techniques, focus tracking techniques, image analysis techniques, and/or the like, to determine a location of a gaze or focus of a user, to determine a position of a head of a user with respect to a display device, and/or the like. The focus location of the user may then be correlated with one of the display devices that is connected to or in communication with the device to identify which display device corresponds to the focus location of the user. The focus location or identified display device may then be compared with the position where the graphical element is to be displayed if no modification or adjustment were made to the graphical element. A difference between these two positions may indicate a visibility of the graphical element will be affected.

Similarly, when multiple display devices are utilized, the state change effectuated by the input provided at the input element may affect a component that corresponds to one of the display devices. For example, a display device may have integral speakers and the state change may affect those speakers. As previously mentioned, the on-screen display graphical element may be displayed on the primary display device, even if that is not the display device including the component that is actually affected by the state change. Thus, in this case, the system may identify the feature as a display device being affected by the state change. In other words, the graphical element modification system may identify the display device of the display devices that includes the component affected by state change corresponding to the graphical element. The system may determine that displaying the graphical element on a display device that is not affected by the state change will affect the visibility of the graphical element. Accordingly, the system may determine that the graphical element should be displayed on the display device that has the component being affected by the state change.

Additionally, the system may utilize other techniques to identify a feature of the content is affecting the visibility of the graphical element. The system may not identify a specific feature of the content, but may instead identify generally that a feature is affecting the visibility of a graphical element by identifying that the user has provided an input that would indicate that a visibility of the graphical element has been affected. As an example, identifying the feature may include identifying characteristics of the content that indicates that a user may have issues viewing content generally. For example, identifying a size of the content, a contrast of content, whether the user utilizes a secondary output in conjunction with the visible output, and/or the like, may indicate that the user has a condition that results in lower visibility of content. By identifying that the user has a condition that may affect the visibility of content in general, the system may also determine that the visibility of the graphical element will also be reduced.

As another example, the system may monitor the user and identify user behavior that would indicate the visibility of the graphical element has been affected. For example, the user may exhibit behavior indicating that the user cannot find the graphical element (e.g., repeatedly providing input the input element while searching for the graphical element, providing audible input indicating the graphical element has not been seen, repeatedly providing input to the input element, providing gesture input indicating the graphical element has not been seen, etc.), the user may express frustration or confusion over whether a state change has occurred, the user may disconnect display devices while providing input to the input element to force the display of the graphical element on a particular display device, and/or the like. Determining if the user behavior indicates the visibility of the graphical element has been affected can be performed using any of the analysis techniques previously discussed. Other techniques for identifying a feature and determining if it affects the visibility of a graphical element are contemplated and possible.

If the graphical element modification system determines at 302 that the feature of the content does not affect a visibility of the graphical element (no branch from 302), the graphical element modification system may make no change to the default characteristics of the graphical element at 303. The graphical element modification system may then transmit instructions to display the graphical element with no adjustments or modifications at 305.

If, on the other hand, the graphical element modification system determines at 302 that the feature of the content does affect a visibility of the graphical element (yes branch from 302), the graphical element modification system may adjust a characteristic of the graphical element at 304. The characteristic of the graphical element that is adjusted may be selected in view of the feature that was identified at 302. In other words, the graphical element modification system adjusts one or more characteristics of the graphical element in order to address the change in visibility due to the feature. Accordingly, the graphical element modification system makes an adjustment to the graphical element in order to compensate or address the feature. The adjustment that is made or the characteristic that is adjusted may be based upon what feature was identified at 302 and how the feature affected the visibility of the graphical element.

Determining how to adjust the characteristic may be identified by a user within a user profile, may be a default value, may be identified by the system over time, and/or the like. Determining how to adjust the characteristic may also be based upon output of one of the analysis techniques. For example, the system could make an adjustment to the graphical element and then perform the same or other analysis as discussed in connection with 302. Based upon the output of the analysis, the system could determine if the adjustment would result in an affect to the visibility of the graphical element that is less than a predetermined threshold, within a particular desired percentage of visibility affect, and/or the like. In other words, the analyses described in connection with 302 are intended to determine if the visibility of the graphical element is affected by the feature to a degree that requires at least one characteristic of the graphical element to be adjusted, the same analyses can be utilized after an adjustment is identified.

This same analysis could be performed here where the output of the analysis would still identify if the visibility of the graphical element is affected by the feature to a degree that requires at least one characteristic of the graphical element to be adjusted. If the visibility of the graphical element is affected by the feature to a degree that does not require at least one characteristic of the graphical element to be adjusted, then the system may determine that the adjustment to the characteristic is sufficient. If the visibility of the graphical element is affected by the feature to a degree that require requires at least one characteristic of the graphical element to be adjusted, then the system may determine that additional or different adjustments need to be made to the same or different characteristics.

As an example of an adjustment to a characteristic, if the feature is a color scheme of the content and the graphical element modification system identifies that the color scheme of the content is similar enough to affect the visibility of the graphical element, the adjustment to a characteristic of the graphical element may be to modify the color scheme of the graphical element so that it contrasts with the color scheme of the content. Thus, the characteristic of the graphical element that is adjusted is the color scheme of the graphical element. Similarly, if the feature is an appearance of the content, the adjustment to a characteristic of the graphical element may be to modify the appearance of the graphical element to distinguish the graphical element from the appearance of the content. In adjusting the appearance, the system may adjust multiple portions of the appearance, may adjust a single portion of the appearance, and/or the like.

As another example of an adjustment to a characteristic, if the feature is a graphical object of focus within the content, the adjustment to a characteristic of the graphical element may be to move the graphical element to be at a different location on the display device as compared to the location of the object of focus. In other words, the system may move the graphical element so that it does not obscure the object of focus. Thus, the characteristic of the graphical element that is adjusted is a location of placement of the graphical element. The location of placement of the graphical element may also be adjusted if the feature is a number of display devices. The location of placement of the graphical element may be adjusted so that the graphical element is presented on the display device that the user it utilizing rather than the display device that is identified as the primary display device, if the display device corresponding to a focus of the user is different than the display device that is identified as the primary display device. The location of placement of the graphical element could also be adjusted to correspond to the display device that has a component that is affected by the state change effectuated by the input provided at the input element.

As another example of an adjustment to a characteristic, if the feature is a general feature, the adjustment to a characteristic of the graphical element may be a similar characteristic of the content that indicates the user has issues viewing content generally. For example, if the size of the content has been increased by the user, the characteristic of the graphical element that is adjusted may be the size of the graphical element. As another example, if the contrast of the content has been adjusted by the user, the characteristic of the graphical element that is adjusted may be the contrast of the graphical element. The characteristic of the graphical element that is adjusted may be different than the characteristic of the content that was adjusted, but may be a characteristic of the graphical element that provides a similar visibility as compared to the characteristic of the content that was adjusted.

The graphical element modification system could also include producing another output in addition to the visible output of the graphical element. For example, the system may produce an audible output that corresponds to receipt of the state change input. Thus, when the graphical element is displayed, an audible output may also be produced. In some cases, the audible output could designate a location of the presentation of the graphical element. For example, using spatial audio technology, the system could produce an audible output that corresponds with a placement location of the graphical element. Other outputs could be produced with the presentation of the graphical element, for example, haptic output, video output, and/or the like.

Similarly, if the feature is a general feature of the content that indicates that the user is not seeing the graphical element when it is displayed, the characteristic that is adjusted may be a characteristic that addresses this issue, for example, a placement location of the graphical element, an animation of the graphical element, a color scheme of the graphical element, or any other characteristic either previously mentioned or that could be adjusted. Other outputs could also be produced with the presentation of the graphical element as previously mentioned.

It should be noted that multiple characteristics of the element can be adjusted, either to account for the same feature or to account for multiple features. Thus, the described adjustments can be made individually or in combination. Additionally, other adjustments to characteristics are contemplated and possible. Thus, the graphical element modification system may make the graphical element more prominent or “stand-out” as compared to how it has been displayed that has resulted in the visibility of the graphical element being affected.

Whether characteristics of the graphical element are unchanged at 303 or are adjusted at 304, the graphical element modification system will transmit instructions to display the graphical element on a display device at 305. Transmitting instructions may include generating the instructions. In the case that multiple display devices are in communication with the device, transmitting the instructions may include generating instructions to display the graphical element on the display device that was identified or selected for the presentation of the graphical element. Generating the instructions includes generating instructions that identify the graphical element to be displayed on the display device and how the graphical element is to be displayed on the display device. In other words, the instructions identify the graphical element that is to be displayed and also identify the characteristic adjustments that are to be made to the graphical element as compared to a default graphical element. Accordingly, when the graphical element is displayed it is displayed with the adjustments to the characteristics. If no adjustments were made to the graphical element, for example, at 303, the generated instructions will include instructions to display the graphical element in the default manner or having the default or traditional characteristics.

Once the instructions are generated, the instructions can be transmitted to the appropriate component(s) in order to actually display the graphical element where and how it is supposed to be displayed. Additionally, if the adjustment to the characteristic included an output in addition to the visual presentation of the graphical element, the generated instructions may include instructions for producing the additional output. Thus, the transmission of the instructions may also include transmission of instructions to the appropriate component(s) to produce the additional output.

As an overall, non-limiting example a user may have a device that is connected to multiple external displays and the device itself has an integral display. The user wants to put the device into a power saving mode and presses an input element corresponding to the power saving mode. When the user provides input to the input element, the system determines that the on-screen display graphical element that indicates the device is now in power-saving mode would traditionally be placed on the primary display, which is the device display, and would traditionally be displayed as an icon having a black background and white design. However, the system identifies that not only is the primary display not being utilized by the user, but the user also has a dark mode color scheme, which means that the content being displayed on the display devices has a dark background with lighter colored text, designs, and/or the like. Thus, if the graphical element were displayed using the traditional placement, the graphical element would not be noticed due to the fact that it would be placed on a display that is not being utilized by the user and also the graphical element would have low visibility due to the fact that it would have a similar color scheme as the color scheme of the content being displayed.

Accordingly, the graphical element modification system adjusts a characteristic of the graphical element to make it more visible to the user. In this example, two characteristics are adjusted, the placement of the graphical element and the appearance of the graphical element. The system identifies which display device the user is utilizing and determines that the graphical element should be displayed on that display device instead of the primary display device. Thus, the system adjusts the placement location characteristic of the graphical element to the used display device. Additionally, since the traditional color scheme of the graphical element would blend into the color scheme of the content, the system adjusts the color scheme of the graphical element to contrast with the color scheme of the content. This may mean changing the color scheme to a white background with a black design, or changing the color scheme to a different color entirely, for example, a blue background with a purple design. Thus, the system adjusts the appearance characteristic of the graphical element to contrast with the color scheme of the content. Once the characteristics have been adjusted, the system transmits instructions to display the graphical element having the adjusted characteristic(s) on the display device.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
identifying, using a graphical element modification system, a graphical element displaying state change information that is to be presented as an overlay on a display device;
identifying, using the graphical element modification system, a feature of content displayed on the display device, wherein the feature affects a visibility of the graphical element;
adjusting, using the graphical element modification system, a characteristic of the graphical element in view of the feature; and
transmitting, using the graphical element modification system, instructions to display the graphical element having the adjusted characteristic.

2. The method of claim 1, wherein the identifying the feature comprises identifying a color scheme of the content.

3. The method of claim 2, wherein the adjusting the characteristic comprises adjusting a color of the graphical element to a color that contrasts with the color scheme of the content.

4. The method of claim 1, wherein the identifying the feature comprises identifying an appearance of the content and wherein the adjusting the characteristic comprises adjusting an appearance of the graphical element to distinguish visually the appearance of the graphical element from the appearance of the content.

5. The method of claim 1, wherein the identifying the feature comprises identifying a graphical object of focus within the content, and wherein the adjusting a characteristic comprises moving the graphical element to be at a different location on the display device as compared to a location of the graphical object of focus.

6. The method of claim 1, wherein the display device is a first display device of a plurality of display devices, and wherein the transmitting the instructions comprises generating the instructions to display the graphical element on one of the plurality of display devices, the one display device being selected to display the graphical element.

7. The method of claim 6, wherein the identifying the feature comprises identifying a focus location of a user and correlating the focus location with the one of the plurality of display devices, and wherein the transmitting the instructions comprises transmitting instructions to display the graphical element having the adjusted characteristic on the one of the plurality of display devices.

8. The method of claim 6, wherein the identifying the feature comprises identifying the one of the plurality of display devices as having a component affected by the state change corresponding to the graphical element.

9. The method of claim 1, wherein the adjusting the characteristic comprises producing an audible output that corresponds to a location of the graphical element.

10. The method of claim 1, wherein the identifying the graphical element comprises receiving an input at an input element associated with the graphical element.

11. A system, the system comprising:
a processor;
a memory device that stores instructions that, when executed by the processor, causes the system to:
identify, using a graphical element modification system, a graphical element displaying state change information that is to be presented as an overlay on a display device;
identify, using the graphical element modification system, a feature of content displayed on the display device, wherein the feature affects a visibility of the graphical element;
adjust, using the graphical element modification system, a characteristic of the graphical element in view of the feature; and
transmit, using the graphical element modification system, instructions to display the graphical element having the adjusted characteristic.

12. The system of claim 11, wherein the identifying the feature comprises identifying a color scheme of the content.

13. The system of claim 12, wherein the adjusting the characteristic comprises adjusting a color of the graphical element to a color that contrasts with the color scheme of the content.

14. The system of claim 11, wherein the identifying the feature comprises identifying an appearance of the content and wherein the adjusting the characteristic comprises adjusting an appearance of the graphical element to distinguish visually the appearance of the graphical element from the appearance of the content.

15. The system of claim 11, wherein the identifying the feature comprises identifying an graphical object of focus within the content, and wherein the adjusting a characteristic comprises moving the graphical element to be at a different location on the display device as compared to a location of the graphical object of focus.

16. The system of claim 11, wherein the display device is a first display device of a plurality of display devices, and wherein the transmitting the instructions comprises generating the instructions to display the graphical element on one of the plurality of display devices, the one display device being selected to display the graphical element.

17. The system of claim 16, wherein the identifying the feature comprises identifying a focus location of a user and correlating the focus location with the one of the plurality of display devices, and wherein the transmitting the instructions comprises transmitting instructions to display the graphical element having the adjusted characteristic on the one of the plurality of display devices.

18. The system of claim 16, wherein the identifying the feature comprises identifying the one of the plurality of display devices as having a component affected by the state change corresponding to the graphical element.

19. The system of claim 11, wherein the adjusting the characteristic comprises producing an audible output that corresponds to a location of the graphical element.

20. A product, the product comprising:
a computer-readable storage device that stores executable code that, when executed by a processor, causes the product to:
identify, using a graphical element modification system, a graphical element displaying state change information that is to be presented as an overlay on a display device;
identify, using the graphical element modification system, a feature of content displayed on the display device, wherein the feature affects a visibility of the graphical element;
adjust, using the graphical element modification system, a characteristic of the graphical element in view of the feature; and
transmit, using the graphical element modification system, instructions to display the graphical element having the adjusted characteristic.
